(19) United States
(12) Patent Application Publication
(10) Pub. No.: US 2013/0136047 A1
(43) Pub. Date: May 30, 2013

(54) SLEEPING EPC FOR ENERGY SAVING IN LTE

(71) Applicants: Xiaowei Zhang, Tokyo (JP); Shingo Shiga, Shingo (JP); Gottfried Punz, Heidelberg (DE); Stefan Schmid, Heidelberg (DE); Toshiyuki Tamura, Tokyo (JP); Anand Raghawa Prasad, Tokyo (JP); Kazuhiro Chiba, Tokyo (JP); Junya Okabe, Tokyo (JP)

(72) Inventors: Xiaowei Zhang, Tokyo (JP); Shingo Shiga, Shingo (JP); Gottfried Punz, Heidelberg (DE); Stefan Schmid, Heidelberg (DE); Toshiyuki Tamura, Tokyo (JP); Anand Raghawa Prasad, Tokyo (JP); Kazuhiro Chiba, Tokyo (JP); Junya Okabe, Tokyo (JP)

(73) Assignees: NEC EUROPE LTD., Heidelberg (DE); NEC CORPORATION, Tokyo (JP)

(21) Appl. No.: 13/810,083

(22) PCT Filed: Jul. 22, 2011
(86) PCT No.: PCT/JP2011/067560

§ 371 Date: Jan. 14, 2013

(30) Foreign Application Priority Data
Aug. 17, 2010 (JP) 2010-182385

(51) Int. Cl. H04W 52/02

(52) U.S. Cl. CPC H04W 52/0203
USPC 370/311

(57) ABSTRACT

In order to save energy in EPS network, some of the MMEs and/or S-GWs are allowed to sleep (power down), when network's traffic load is decreased. When the traffic load becomes heavier, the network can power up some of the formerly sleeping MMEs and/or S-GWs.

### TECHNICAL FIELD

The present invention relates to energy saving for Evolved Packet Core (EPC) in Long Term Evolution (LTE) system.

### BACKGROUND ART

Compared to third-generation (3G) communication system, Evolved Packet System (EPS) networks will demand more power and thus produce more carbon dioxide (CO2). While facing the growing problems of climate change and energy shortages, energy saving appears essential in mobile communication industry. Energy saving products and mechanism are necessary to reduce energy consumption, and thus reduce the growth in energy supply needed to keep up with the demand.

### CITATION LIST

### Non Patent Literature

NPL 1: 3GPP TS 23.401, “General Packet Radio Service (GPRS) enhancements for Evolved Universal Terrestrial Radio Access Network (E-UTRAN) access (Release 9)”, V9.5.0, 2010-06

### SUMMARY OF INVENTION

A mechanism is provided in this invention for energy saving in LTE core network. Considered that during night a large number of the users connecting mobile network for service is decreased, it is not necessary for the network to keep all the Mobility Management Entitys (MMEs) and/or Serving Gateways (S-GWs) working during that time. We extend it to a more general sense that whenever the traffic is not heavily loaded in the core network, some of the MMEs and/or S-GWs can power down and thus the goal of energy saving and pollution reduction can be achieved. MME pool defined in Non Patent Literature (NPL) 1 makes this mechanism possible.

### Terminology

Sleeping MME: A MME is going to power down or in power down state (for the purpose of energy saving).

Normal MME: A MME remaining permanently active, i.e. not in power down state. Sleeping S-GW: An S-GW is going to power down or in power down state (for the purpose of energy saving).

Normal S-GW: An S-GW remaining permanently active, i.e. not in power down state.

This invention considers energy saving in LTE core network. It is not necessary for all the MMEs and S-GWs to stay activated (i.e. remain in normal operation), if the network does not have heavy traffic load. When the network is aware of the decreased traffic load, some MMEs and/or some S-GWs will power down to reduce electricity consumption and CO2 production (these are called “sleeping” MMEs and “sleeping” S-GWs; other MMEs and S-GW are called “normal”). Similarly, when the traffic load becomes heavier, network can power up some of the formerly sleeping MMEs.

Meanwhile, the impact to UE should be none or as little as possible.

### ADVANTAGEOUS EFFECTS OF INVENTION

Having MMEs and/or S-GWs in power down state for some time saves the energy and reduce the CO2 production; based on typical traffic and load considerations, the number of MMEs/S-GWs and their aggregated time in this state is considerable.

Re-using the S1 based handover and tracking area updating procedures will not cause impacts on UE, neither will it bring much burden to the network.

The change of MME and/or S-GW procedure is transparent to UE and the existing system.

### BRIEF DESCRIPTION OF DRAWINGS

FIG. 1 is a sequence diagram showing operation of Sleeping MME when UE in connected mode.

FIG. 2 is a sequence diagram showing operation of Sleeping MME when UE in idle mode.

FIG. 3 is a sequence diagram showing operation of Sleeping S-GW when UE in connected mode.

FIG. 4 is a sequence diagram showing operation of Sleeping S-GW when UE in idle mode.

### DESCRIPTION OF EMBODIMENTS

The object of the invention is achieved by a mechanism that to allow some of the MMEs and/or S-GWs to sleep (power down) when network's traffic load is decreased. User Equipments (UEs) in both connected and idle status are considered.

### 1. Sleeping MME

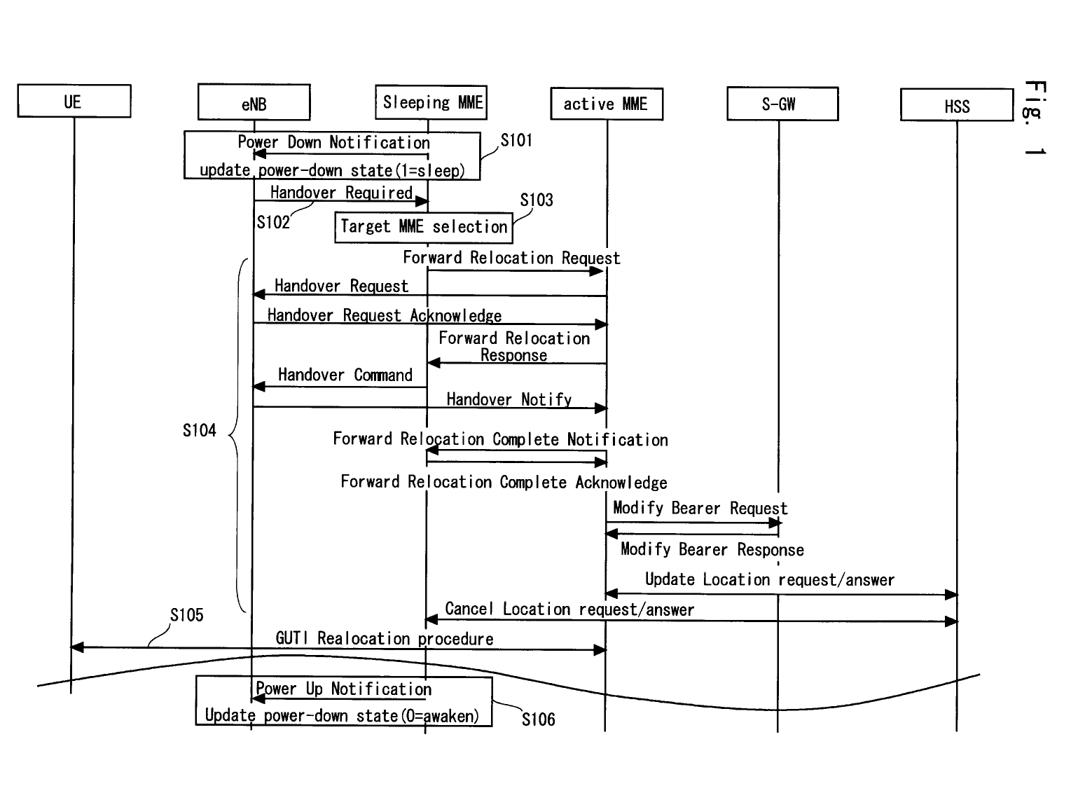

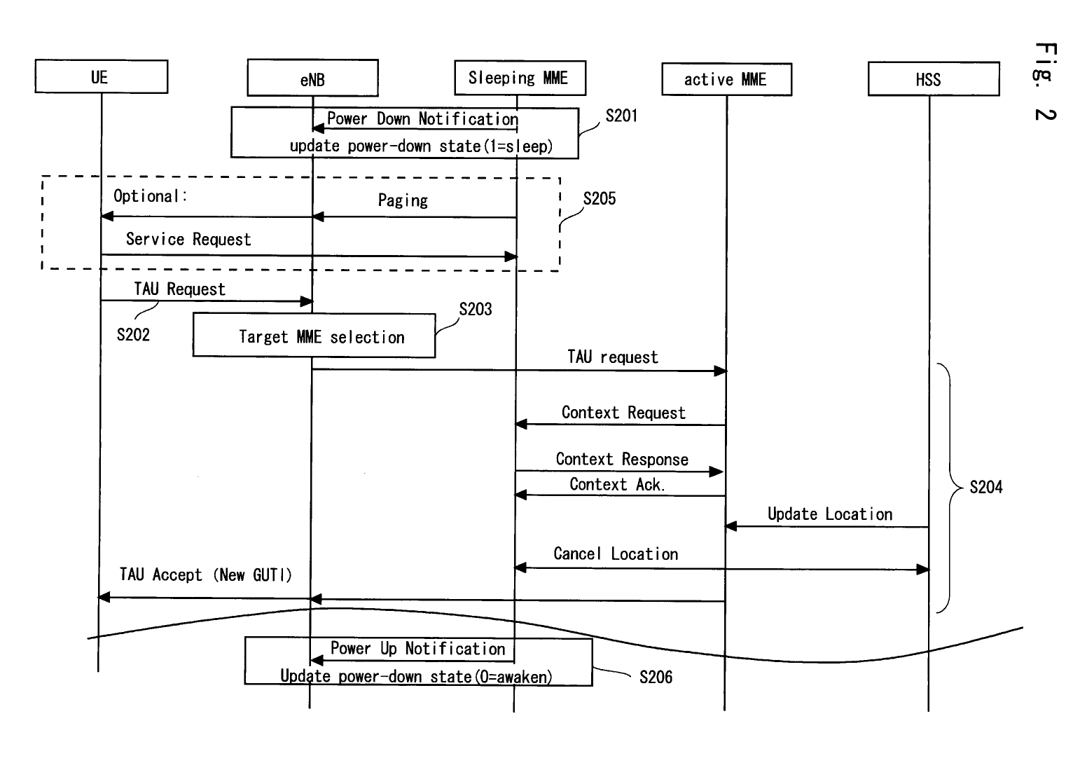

In case of MME goes to sleep, the MME sends a “Power down” notification message to all connected enhanced Node B (eNBs) when it is about to sleep. This MME is called sleeping MME.
For UEs in connected mode, S1 based handover procedure is partly re-used to forward the UE contexts from sleeping MME to normal MMEs in the same pool. No Radio Resource Control (RRC) signaling between eNB and UE happens, i.e, the eNB will not send a “Measurement control” message to trigger UEs to send measurement reports. Power down notification message triggers eNB to initiate S1 based handover to a normal MME by sending sleeping MME the “Handover required” message (Steps S101 and S102 shown in FIG. 1). When the sleeping MME receives the “Handover required” message from eNB, it will perform MME selection to select a normal MME (which is neither itself nor any other MME going to sleep) (Step S103). The sleeping MME can select the normal MME by e.g., preliminarily sharing status between MMEs in the same pool. Meanwhile, the sleeping MME will inform other MMEs about its status, so that other MMEs will not select it as a normal MME. Furthermore, once a MME is selected by any sleeping MME, it should not send a “Power down” notification. Then, the sleeping MME sends “Forward Relocation Request” message to the normal MME, thereby forwarding the UE contexts to the normal MME. After the handover procedure is finished (Step S104), the newly selected MME will perform Globally Unique Temporary Identity (GUTI) reallocation procedure to allocate UE a new GUTI (Step S105).
For UE in idle mode, tracking area updating (TAU) procedure is re-used. After sending the “Power down” notification message (Step S201 shown in FIG. 2), sleeping MME enters the Power down preparation phase (Annex 1). During the preparation phase, all UEs handled by this MME will keep sending “Tracking area updating request” message for given period (Step S202). When eNBs receive such a message, they select a normal MME (Step S203). Then, each eNB forwards the “Tracking area updating request” message to the selected MME, thereby triggering the selected MME to acquire the UE contexts from the sleeping MME. The selected MME will allocate a new GUTI and send it to UE in TAU accept message (Step S204). Once the power down preparation phase is over, the MME enters power down or sleeping status. Normal MME selection follows the same rules as those for connected UEs. For example, each eNB selects an MME, which has not sent the “Power down” notification message, from among MMEs connected to each eNB.

Alternatively, sleeping MME can also page idle mode UEs to trigger the UE to perform the service request procedure (Step S205); after that, the involved eNB can issue an RRC release with cause “loadBalancingTAURequired”, this will cause subsequently a tracking area update. This variant of the procedure allows to reach the MME sleeping mode faster.

The sleeping MME are capable to wake up when for example, the time is up according to network configuration, eNB is overloaded, or disaster, etc. It will send a Power up notification to eNB (Steps S106 and S206 respectively shown in FIGS. 1 and 2).

### 2. Sleeping S-GW

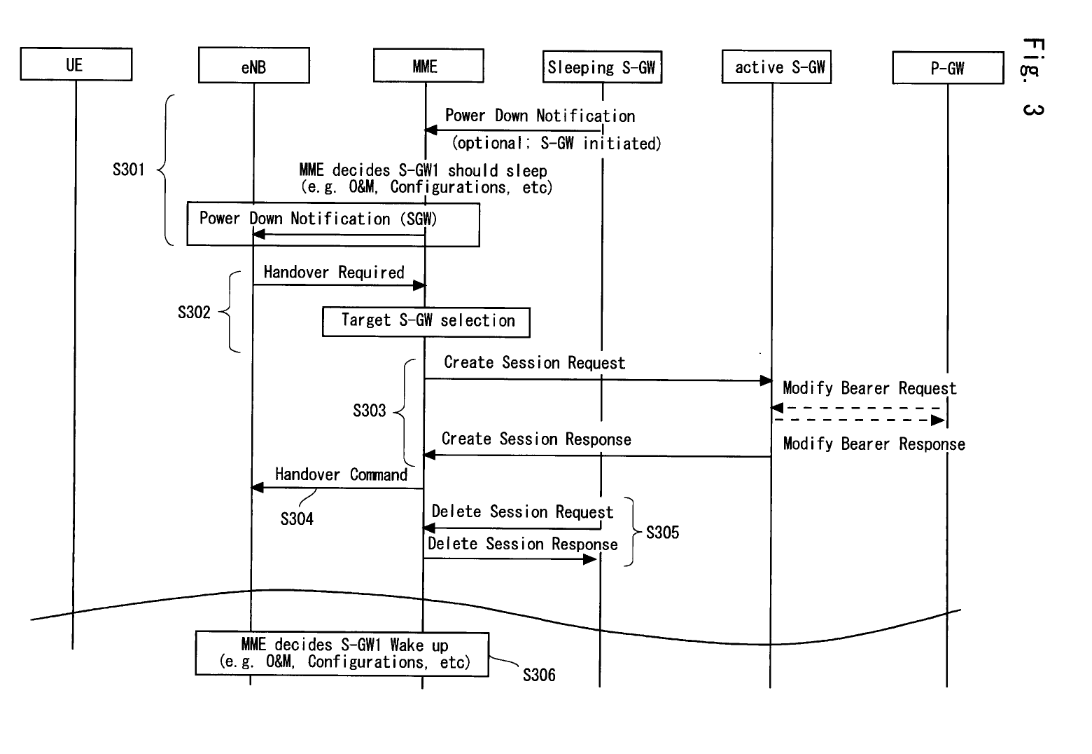

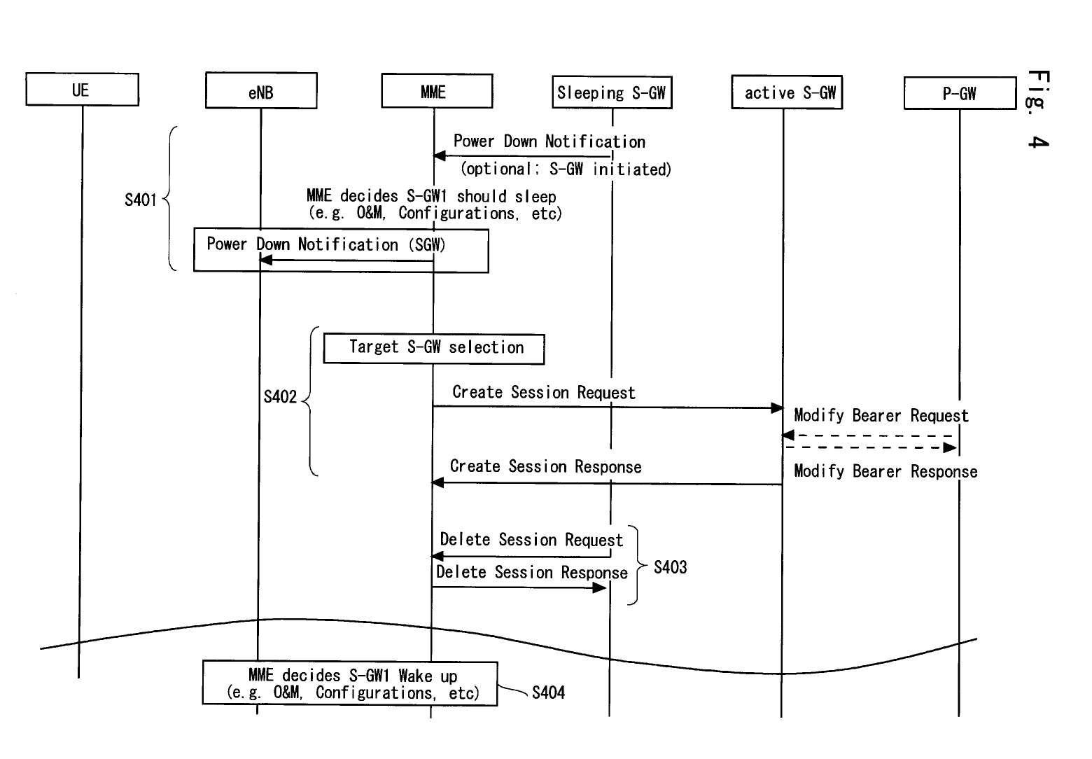

In case of a sleeping S-GW, the MME which is associated with the S-GW sends a “Power down” notification message to all connected eNBs, with a parameter to indicate that the S-GW is going to sleep, and to the S-GW targeted for power down (Steps S301 and S401 respectively shown in FIGS. 3 and 4). Optionally, the S-GW can send a “Power down” indication to all MMEs in the pool when it initiates sleeping or directly to all connected eNBs. An S-GW can go to sleep when all of its session is deleted (Steps S305 and S403). There is no specific message for power up needed, since MMEs will determine whether or not a previously sleeping S-GW has waken up and can allocate it freely within other (active or idle mode mobility) procedures (Steps S306 and S404). This has no impact on UEs that whether an S-GW in or not in sleeping mode.
For UEs in connected mode, S1 based handover procedure is also partly re-used in a way that no RRC signaling between eNB and UE happens. eNB sends MME the “Handover required” message, and MME will perform S-GW selection to select a S-GW which is not going to sleep (Step S302). The MME will then establish a session with this normal S-GW (Step S303). The handover procedure ends after MME sent the “Handover Command” message to eNB (Step S304) (see NPL 1, subclause 5.5.1.2).
For UE in idle mode, UE does not need to be aware of S-GW change. MME will perform S-GW selection to select a normal S-GW and establish the session with it (Step S402).

Note that in case of sleeping S-GWs, the MME makes the decision which S-GWs can go to sleep. Optionally, S-GWs can make the decision themselves and inform MMEs.

In order to prevent the MMEs, which are not informed by the sleeping S-GWs, from selecting a sleeping S-GW, S-GW should indicate DNS (Domain Name System) about its sleeping. DNS should update sleeping S-GW's status, so that MME will not select a sleeping S-GW. In the same way, when a sleeping S-GW wakes up, it is status should be updated in

DNS so that it can be selected by MMEs.

### 3. Both MME And S-GW Go Sleep

It is possible that both MME and S-GW go to sleep. In this case, it is sufficient that:
sleeping MME should not select any MME or S-GW that is going to sleep;
active MME should not select S-GWs which are going to sleep;
an MME should assure that not all S-GWs in the pool, which can connect with the MME, go to sleep at nearly the same time (a minimal time interval between sleep times of S-GWs is required, in order to avoid overload in signaling).

### Annex 1. Power Down Preparation Phase

In power down preparation phase, for default settings of timers, a timer of 66 min 50 sec length is needed as defined below in case idle mode UEs are not paged in order to be moved to another MME:

T3412+T3411*5 times+T3402=54 min+10 sec*5+12 min

Otherwise, the power down preparation phase can be set to the max time needed to page all UEs to move them to another MME.

Note that although the illustration is omitted, the MME can be configured by, for example, transceivers which respectively conduct communication with connected eNB(s), other MME(s) in the same pool and S-GWs, and a controller which controls their transceivers to execute the processes respectively shown in FIGS. 1 to 4 or processes equivalent thereto.

Further, the eNB can be configured by, for example, a transceiver which conducts communication with MMEs, a transceiver which conducts wireless communication with the UE, and a controller which controls their transceivers to execute the processes respectively shown in FIGS. 1 to 4 or processes equivalent thereto.

Furthermore, the S-GW can be configured by, for example, a transceiver which conducts communication with MMEs in the same pool, and a controller which controls this transceiver to execute the processes respectively shown in FIGS. 3 and 4 or processes equivalent thereto.

Note that the present invention is not limited to the above-mentioned exemplary embodiments, and it is obvious that various modifications can be made by those of ordinary skill in the art based on the recitation of the claims.

This application is based upon and claims the benefit of priority from Japanese patent application No. 2010-182385, filed on Aug. 17, 2010, the disclosure of which is incorporated herein in its entirety by reference.

The whole or part of the exemplary embodiments disclosed above can be described as, but not limited to, the following supplementary notes.

### Supplementary Note 1

### Method To Decide Which MME Goes To Sleep

It can be pre-defined or on-time set by operator, and the sleeping MMEs can be periodically changed, e.g. every night.
Network can dynamically choose the MMEs which have less traffic load to sleep.

### Supplementary Note 2

### New Messages Of Power Down Notification And Power Up Notification

Power down notification is sent to eNB by a sleeping MME or S-GW (in case that S-GW is capable of making the decision) then it is triggered to sleep. In the same way, a sleeping MME sends Power up notification to eNB to indicate that it is waking up from power down state.

### Supplementary Note 3

### Message of Power Down Notification Triggers eNB To Initiate S1 Based Handover

Upon receiving Power down notification from MME, eNB will initiate S1 based handover by sending Handover required message to MME and omit the RRC signaling between UE.

### Supplementary Note 4

### Power Down Preparation Phase

Since MME has to forward its associated UE to an active or unsleeping MME, it should not power down right after it sends out the Power down notification. It will enter power down preparation phase, and wait till UEs established connection with an active MME.

### Supplementary Note 5

### Re-Use S1 Based Handover With MME Relocation For Forwarding Connected Mode UE To Unsleeping MME

This handover is slightly different from the normal S1 based handover, in the way that eNB is both the source and the target while sleeping MME is the source MME and unsleeping MME is the target MME.

### Supplementary Note 6

### Re-Use S1 Based Handover With SGW Relocation To Implement Sleeping S-GW

Part of the handover procedure (step 2-9 in NPL 1) is re-used in case of sleeping S-GW. In the Handover command message from MME to eNB, the necessary information about selected unsleeping S-GW can be provided.

### Supplementary Note 7

### Re-Use Tracking Area Updating Procedure For Forwarding Idle UE To Active MME

In order not to impact UE's behavior and cause unnecessary signaling, sleeping MME waits UE in idle mode performing tracking area updating procedure. During which, eNB will perform MME selection to select unsleeping MME for the UE.

Alternatively, sleeping MME can also page idle mode UEs (with an appropriate cause) to trigger the UE to perform the tracking area update, which allows speeding up the MME sleeping procedure.

### Supplementary Note 8

### Trigger MME To Sleep

a timer can be stored and set in sleeping MMEs, e.g MME can sleep during night;
or thresholds for powering down and up can be set by the operator, i.e. when the traffic load of network decreased to the threshold, some of the MMEs can start sleeping, in the same way, when the traffic load is increasing and reaches the threshold, some or all the sleeping MMEs will be activated; this can be triggered or managed via OAM (Operations, Administration and Maintenance).

### Supplementary Note 9

### Unsleeping MME Selection Strategy

MMEs should know about each other's sleeping status, such that sleeping MME will not select a MME which is in Power down preparation phase or Power down status. This can be realized by sleeping MMEs sending out message to inform that it is going to sleep.
If a sleeping MME is selected by another sleeping MME, it should inform the request sender and reject the request with a proper cause.
sleeping MME is able to dynamically select unsleeping MME with light load.

### Supplementary Note 10

### Trigger Sleeping MME To Wake Up

There are a few events can trigger MME to wake up from sleeping status.
O&M or configurations: e.g. set timer of date and period in MME
Disasters: e.g. ETWS (Earthquake and Tsunami Warning System)
From eNodeB or unsleeping MME: e.g. eNB or MME is overloaded.

### Supplementary Note 11

### Purging For UE In Idle Mode

Normally MME sends Purge UE request when UE has been detached for 24 hours. However, if sleeping MME wakes up with status unchanged, 24 hours might not be reached and Purge would not be triggered.

Therefore, sleeping MME forwards detached-UE's context to the selected unsleeping MME, then this will be taken care by the unsleeping MME.

### Supplementary Note 12

### S-GW Information Update In DNS

A sleeping S-GW's status should be updated in DNS (Domain Name System), either by S-GW or MME in order to influence the DNS-based S-GW selection process (i.e. a sleeping S-GW should not be resolved by the DNS during its sleeping phase) due to the reasons given below:
To prevent MMEs, which the sleeping S-GW is associated with, to select it during its sleeping phase,
To prevent other MMEs, that S-GW is not associated with, to select it.

In order to avoid that a MME may select a sleeping S-GW because of a DNS caching, the caching time for DNS resolution for S-GW selection may need to be reduced accordingly.

When a sleeping S-GW wakes up, the DNS should also be updated to allow selection of the S-GW for new PDN (Packet Data Network) connections.

1. A node that manages mobility of one or more UEs (User Equipments), the node comprising:
a first unit that determines whether or not to power down the node, based on a traffic load in a network;
a second unit that notifies, when it is determined to power down the node, a base station connected to the node that the node is powered down in order to trigger the base station to initiate handover; and
a third unit that sends, upon receiving from the base station a first request for the handover, a second request for forwarding contexts of a UE in connected mode to a different node that can manage the mobility of the UEs.

2. The node according to claim 1, further comprising:
a unit that waits a predetermined period of time to power down the node, the period of time being set to the one during which a UE in idle mode can establish connection with the different node.

3. The node according to claim 1, wherein the first request comprises a Handover Required message used in a S1 based handover manner, and the second request comprises a Forward Relocation Request message used in the S1 based handover manner.

4. The node according to claim 1,
wherein the first unit further determines whether or not to power down a gateway that routes and forwards data packets for the UEs, based on the traffic load in the network,
wherein the second unit notifies, when it is determined to power down the gateway, the base station that the gateway is powered down in order to trigger the base station to initiate the handover,
wherein the third unit sends, upon receiving the first request from the base station, a third request for establishing session to a different gateway that can route and forward the data packets for the UEs, and returns a response to the base station, the response including information on the different gateway.

5. The node according to claim 4, wherein the third request comprises a Create Session Request message used in a S1 based handover manner, and the response comprises a Handover Command message used in the S1 based handover manner.

6. The node according to claim 1, further comprising:
a unit that pages a UE in idle mode to be triggered to perform TAU (Tracking Area Updating) procedure.

7. The node according to claim 1, wherein the first unit determines to power down the node, at a predetermined period of time during which the traffic load is predicted to be decreased compared with a different period of time, or when the traffic load is decreased to a predetermined threshold.

8. The node according to claim 1, further comprising:
a unit that informs, when it is determined to power down the node, other nodes capable of managing the mobility of the UEs that the node is powered down.

9. The node according to claim 1,
wherein the first unit further determines, after the node is powered down, whether or not to power up the node based on the traffic load in the network,
wherein the second unit notifies, when it is determined to power up the node, the base station that the node is powered up.

10. The node according to claim 9, wherein the first unit determines to power up the node, at a predetermined period of time during which the traffic load is predicted to be increased compared with a different period of time, in times of disaster, or when the base station or the different node is overloaded.

11. The node according to claim 1, wherein the third unit includes, in the second request, contexts of a UE detached from the node.

12. A base station being capable of wirelessly communicating with one or more UEs (User Equipments), the base station comprising:
a first unit that receives, from a node that is connected to the base station and manages mobility of the UEs, a first notification indicating that the node is powered down; and
a second unit that sends to the node a first request for handover, upon reception of the first notification.

13. The base station according to claim 12, wherein the first request comprises a Handover Required message used in a S1 based handover manner.

14. The base station according to claim 12, further comprising:
a unit that receives, from a UE in idle mode, a second request for TAU (Tracking Area Updating);
a unit that selects a different node that can manage the mobility of the UEs, from among nodes that are connected to the base station and other than the node from which the first notification is received; and
a unit that transfers the second request to the different node.

15. The base station according to claim 12,
wherein the first unit further receives from the node a second notification indicating that a gateway is powered down, the gateway routing and forwarding data packets for the UEs,
wherein the second unit sends the first request to the node, upon receiving the second notification,
wherein the first unit receives from the node a response to the first request, the response including information on a different gateway that routes and forwards the data packets for the UEs as a substitute for the gateway.

16. The base station according to claim 15, wherein the response comprises a Handover Command message used in a S1 based handover manner.

17. A gateway that routes and forwards data packets for one or more UEs (User Equipments), the gateway comprising:
a unit that determines whether or not to power down the gateway, based on a traffic load in a network; and
a unit that notifies, when it is determined to power down the gateway, a node managing mobility of the UEs that the gateway is powered down.

18. The gateway according to claim 17, further comprising:
a unit that instructs a DNS (Domain Name System) not to perform resolution for the gateway while the gateway is powered down.

19. (canceled)

20. A method of controlling a node that manages mobility of one or more UEs (User Equipments), the method comprising:
determining whether or not to power down the node, based on a traffic load in a network;
notifying, when it is determined to power down the node, a base station connected to the node that the node is powered down in order to trigger the base station to initiate handover; and
sending, upon receiving from the base station a first request for the handover, a second request for forwarding contexts of a UE in connected mode to a different node that can manage the mobility of the UEs.

21. The method according to claim 20, further comprising:
waiting a predetermined period of time to power down the node, the period of time being set to the one during which a UE in idle mode can establish connection with the different node.

22. The method according to claim 20, wherein as the first request, a Handover Required message used in a S1 based handover manner is received, and as the second request, a Forward Relocation Request message used in the S1 based handover manner is sent.

23. The method according to claim 20, further comprising:
determining whether or not to power down a gateway that routes and forwards data packets for the UEs, based on the traffic load in the network;
notifying, when it is determined to power down the gateway, the base station that the gateway is powered down in order to trigger the base station to initiate the handover;
sending, upon receiving the first request from the base station, a third request for establishing session to a different gateway that can route and forward the data packets for the UEs; and
returning a response to the base station, the response including information on the different gateway.

24. The method according to claim 23, wherein as the third request, a Create Session Request message used in a S1 based handover manner is sent, and as the response, a Handover Command message used in the S1 based handover manner is returned.

25. The method according to claim 20, further comprising:
paging a UE in idle mode to be triggered to perform TAU (Tracking Area Updating) procedure.

26. The method according to claim 20, wherein it is determined to power down the node, at a predetermined period of time during which the traffic load is predicted to be decreased compared with a different period of time, or when the traffic load is decreased to a predetermined threshold.

27. The method according to claim 20, further comprising:
informing, when it is determined to power down the node, other nodes capable of managing the mobility of the UEs that the node is powered down.

28. The method according to claim 20, further comprising:
determining, after the node is powered down, whether or not to power up the node based on the traffic load in the network; and
notifying, when it is determined to power up the node, the base station that the node is powered up.

29. The method according to claim 28, wherein it is determined power up the node, at a predetermined period of time during which the traffic load is predicted to be increased compared with a different period of time, in times of disaster, or when the base station or the different node is overloaded.

30. The method according to claim 20, wherein contexts of a UE detached from the node are included in the second request.

31. A method of controlling a base station that can wirelessly communicate with one or more UEs (User Equipments), the method comprising:
receiving, from a node that is connected to the base station and manages mobility of the UEs, a first notification indicating that the node is powered down; and
sending to the node a first request for handover, upon reception of the first notification.

32. The method according to claim 31, wherein as the first request, a Handover Required message used in a S1 based handover manner is sent.

33. The method according to claim 31, further comprising:
receiving, from a UE in idle mode, a second request for TAU (Tracking Area Updating);
selecting a different node that can manage the mobility of the UEs, from among nodes that are connected to the base station and other than the node from which the first notification is received; and
transferring the second request to the different node.

34. The method according to claim 31, further comprising:
receiving from the node a second notification indicating that a gateway is powered down, the gateway routing and forwarding data packets for the UEs;
sending the first request to the node, upon receiving the second notification; and
receiving from the node a response to the first request, the response including information on a different gateway that routes and forwards the data packets for the UEs as a substitute for the gateway.

35. The method according to claim 34, wherein as the response, a Handover Command message used in a S1 based handover manner is received.

36. A method of controlling a gateway that routes and forwards data packets for one or more UEs (User Equipments), the method comprising:
determining whether or not to power down the gateway, based on a traffic load in a network; and
notifying, when it is determined to power down the gateway, a node managing mobility of the UEs that the gateway is powered down.

37. The method according to claim 36, further comprising:
instructing a DNS (Domain Name System) not to perform resolution for the gateway while the gateway is powered down.

38. (canceled)
